(19) United States
(12) Patent Application Publication
(10) Pub. No.: US 2017/0300550 A1
(43) Pub. Date: Oct. 19, 2017

(54) Data Cloning System and Process

(71) Applicant: StoreReduce, Sunnyvale, CA (US)

(72) Inventors: Mark Alexander Hugh Emberson, Glebe (AU); Mark Leslie Cox, Christchurch (NZ); Tyler Wayne Power, Canterbury (NZ)

(73) Assignee: StoreReduce, Sunnyvale, CA (US)

(21) Appl. No.: 15/600,641

(22) Filed: May 19, 2017

Related U.S. Application Data
(63) Continuation-in-part of application No. 15/298,897, filed on Oct. 20, 2016.
(60) Provisional application No. 62/373,328, filed on Aug. 10, 2016.
(60) Provisional application No. 62/339,090, filed on May 20, 2016.
(60) Provisional application No. 62/249,885, filed on Nov. 2, 2015.
(60) Provisional application No. 62/339,090, filed on May 20, 2016.

(51) Int. Cl. G06F 17/30; G06F 11/20

(52) U.S. Cl. CPC G06F 17/30575; G06F 17/30578; G06F 17/3033; G06F 17/30286; G06F 11/2056

(57) ABSTRACT

A data cloning system and process is disclosed. A device receives files via a network from a remotely disposed computing device and partitions the received files into data objects. The device creates hash values for the data objects and stores the data objects on remotely disposed storage systems at location addresses. The device stores in records of a storage table, for each of the data objects, the hash values and corresponding location addresses. The device receives an indication to clone a portion of the received files and performs the clone operation by storing in records of a second storage table, a key for each cloned file referring to the same set of hash values and location addresses as the corresponding original file. This has the effect of cloning the original received files without needing to copy the corresponding data objects.

### PRIORITY AND RELATED APPLICATIONS

This application claims the benefit of U.S. provisional application No. 62/249885, filed Nov. 2, 2015; U.S. provisional application No. 62/373328, filed Aug. 10, 2016; U.S. provisional application No. 62/339090, filed May 20, 2016; and is a continuation in part of U.S. patent application Ser. No. 15/298897, filed Oct. 20, 2016; the contents of which are hereby incorporated by reference.

### TECHNICAL FIELD

These claimed embodiments relate to a method for cloning of stored de-duplicated data and more particularly to using an intermediary data deduplication device to virtually clone data objects via a network.

### BACKGROUND OF THE INVENTION

A data storage system using an intermediary networked device to virtually clone stored deduplicated data objects on a remotely located object storage device(s) is disclosed.

Deduplication is a specialized data compression technique for eliminating duplicate copies of repeating data. Deduplication of data is typically done to decrease the cost of storage of the data using a specially configured storage device having a deduplication engine internally connected directly to a storage drive.

The deduplication engine within the storage device receives data from an external device. The deduplication engine creates a hash from the received data which is stored in a table. The table is scanned to determine if an identical hash was previously stored in the table. If it was not, the received data is stored on the internal storage drive, and a location pointer for the received data is stored in an entry within the table along with hash of the received data. When a duplication of the received data is detected, an entry is stored in the table containing the hash and an index pointing to the location where the duplicated file is stored.

This system has the deduplication engine directly coupled to an internal storage drive to maintain low latency and fast storage of the hash table. However, the data is stored in additional specialized storage devices. Further copying the files once deduplicated between multiple storage devices is a long and time consuming process.

### SUMMARY OF THE INVENTION

A processing device to clone files stored on a remotely disposed computing devices that includes circuitry to receive files via a network from a remotely disposed computing device and circuitry to partition the received files into data objects. The circuitry creates hash values for the data objects and circuitry stores the data objects on remotely disposed storage systems at location addresses. Circuitry stores in records of a storage table, for each of the data objects, the hash values and a corresponding location addresses. Circuitry is provided to receive an indication to clone a portion of the received files. In response to the indication to clone the portion of the received files, the clone operation is performed by storing in records of a second storage table, a key for each cloned file referring to the same set of hash values and location addresses as the corresponding original file. Performing the clone operation in this manner has the effect of cloning the original received files without needing to copy the corresponding data objects.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is a simplified schematic diagram of a deduplication storage system and cloning system;

FIG. 2 is a simplified schematic and flow diagram of a storage system in which a client application on a client device communicates through an application program interface (API) directly connected to a cloud object store;

FIG. 3 is a simplified schematic diagram and flow diagram of a de-duplication storage system and cloning system in which a client application communicates via a network to an application program interface (API) at an intermediary computing device, and then stores data via a network to a cloud object store;

FIG. 4 is a simplified schematic diagram of an intermediary computing device shown in FIG. 3;

FIG. 5 is a flow chart of a process for storing and deduplicating data executed by the intermediary computing device shown in FIG. 3;

FIG. 6 is a flow diagram illustrating the process for storing de-duplicated data;

FIG. 7 is a flow diagram illustrating the process for storing de-duplicated data executed on the client device of FIG. 3;

FIG. 8 is a flow diagram illustrating the process for storing and de-duplicating data executed by the intermediary computing device shown in FIG. 3 in greater detail;

FIG. 8b is a data diagram illustrating the partitioning of data into data objects for storage;

FIG. 9 is a data diagram illustrating the partitioning of data objects for storage in memory;

FIG. 10 is a data diagram illustrating a relation between a hash and the data objects that are stored in memory;

FIG. 11 is a data diagram illustrating the file or object table which maps file or object names to the location addresses where the files are stored;

FIG. 12 is a flow chart of a process for writing data to a new object or to overwrite an existing clone object executed by the intermediary computing device shown in FIG. 3;

FIG. 13 is a flow chart of a process for creating a virtual copy of data with the intermediary computing device shown in FIG. 3;

FIG. 14 is a simplified flow diagram illustrating a scenario of cloning in which the data to be cloned is to be kept segregated; and

FIG. 15 is a flow chart of a process for cloning in which the data to be cloned is to be kept segregated.

### DETAILED DESCRIPTION

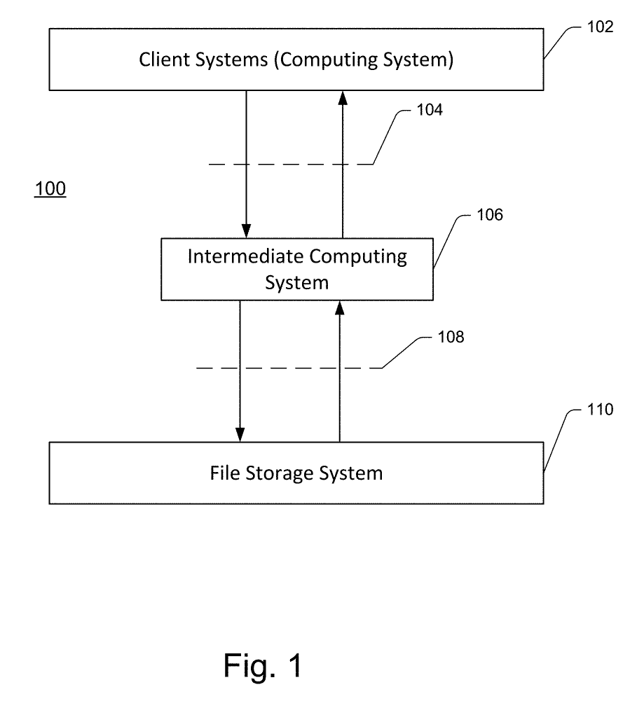

Referring to FIG. 1, there is shown a deduplication storage system 100. Storage system 100 includes a client system 102, coupled via network 104 to Intermediate Computing system 106. Intermediate computing system 106 is coupled via network 108 to remotely located File Storage system 110.

Storage system 100 transmits data objects to intermediate computing system 106 via network 104. Intermediate computing system 106 includes a process for storing the received data objects on file storage system 100 to reduce duplication of the data objects when stored on file system 100.

Storage system 100 transmits requests via network 104 to intermediate computing system 106 for data store on file storage system 110. Intermediate computing system responds to the requests by obtaining the deduplicated data on file system 110, and transmits the obtained data to client system 100.

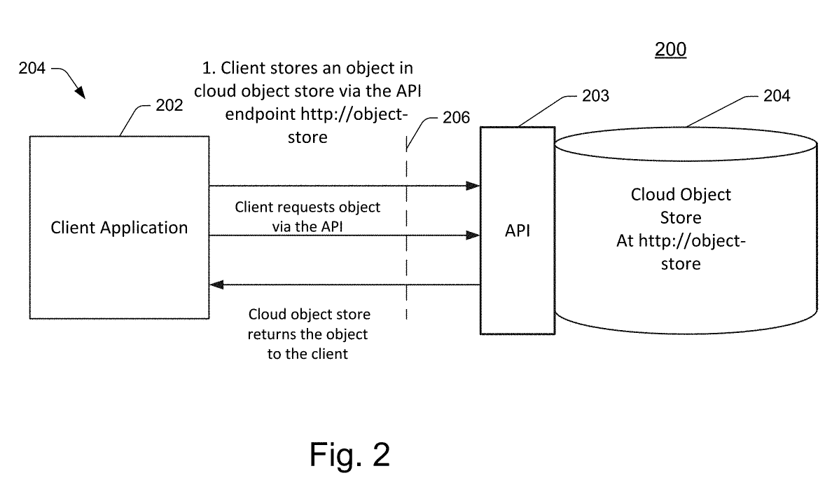

Referring to FIG. 2, a storage system 200 that includes a client application 202 on a client device 204 that communicates via a network 206 through an application program interface (API) 211 directly connected to a cloud object store 210

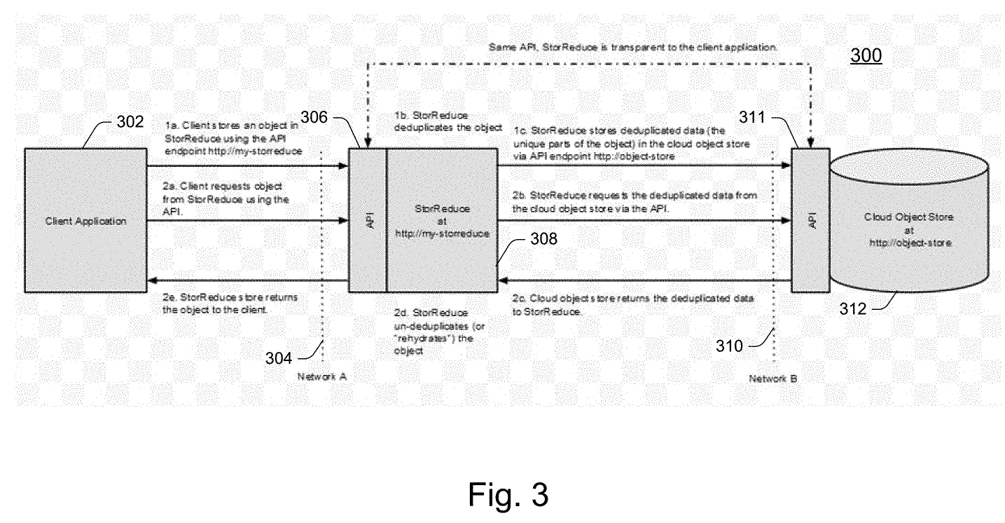

Referring to FIG. 3, there is shown a deduplication storage system 300 including a client application 302 communicates data via a network 304 to an application program interface (API) 311 at an intermediary computing device 308. The data is deduplicated on intermediary computing device 308 and then the unique data is stored via a network 310 and API 311 (API 211 in FIG. 2) on a remotely disposed computing device 312 such as a cloud object store system that may typically be administered by an object store service.

Exemplary Networks 304 and 310 include, but is not limited to, an Ethernet Local Area Network, a Wide Area Network, an Internet Wireless Local Area Network, an 802.11g standard network, a Wi-Fi network, a Wireless Wide Area Network running protocols such as GSM, WiMAX, or LTE.

Examples of the intermediary computing device 308, includes, but is not limited to, a Physical Server, a personal computing device, a Virtual Server, a Virtual Private Server, a Network Appliance, and a Router/Firewall.

Exemplary remotely disposed computing device 312 may include, but is not limited to, a Network Fileserver, an Object Store, an Object Store Service, a Network Attached device, a Web server with or without WebDAV.

Examples of the cloud object store include, but are not limited to, OpenStack Swift, IBM Cloud Object Storage and Cloudian HyperStore. Examples of the object store service include, but are not limited to, Amazon® S3, Microsoft® Azure Blob Service and Google® Cloud Storage.

During operation Client application 302 transmits a file via network 304 for storage by providing an API endpoint (such as http://my-storereduce.com) 306 corresponding to a network address of the intermediary device 308. The intermediary device 308 then deduplicates the file as described herein. The intermediary device 308 then stores the deduplicated data on the remotely disposed computing device 312 via API endpoint 311. In one exemplary implementation, the API endpoint 306 on the intermediary device is virtually identical to the API endpoint 311 on the remotely disposed computing device 312.

If a client application needs to retrieve a stored data file, the client application 302 transmits a request for the file to the API endpoint 306. The intermediary device 308 responds to the request by requesting the deduplicated data from remotely disposed computing device 312 via API endpoint 311. The cloud object store 312 and API endpoint 311 accommodate the request by returning the deduplicated data to the intermediate device 308, that is then un-deduplicated by the intermediate device 308. The intermediate device 308 via API 306 returns the file to client application 302.

In one implementation, device 308 and a cloud object store is present on device 312 that present the same API to the network. In one implementation, the client application 302 uses the same set of operations for storing and retrieving objects. Preferable the intermediate device 307 is almost transparent to the client application. The client application 302 does not require an indication that the intermediate API 311 and intermediate device 306 are present. When migrating from a system without the intermediate processing device 308 (as shown in FIG. 2) to a system with the intermediate processing device, the only change for the client application 302 is that location of the endpoint of where it stores data has changed in its configuration (e.g., from http://objectstore to http://mystorreduce). The location of the intermediate processing device can be physically close to the client application to reduce the amount of data crossing Network 310 which can be a low bandwidth Wide Area Network.

### Example Computing Device Architecture

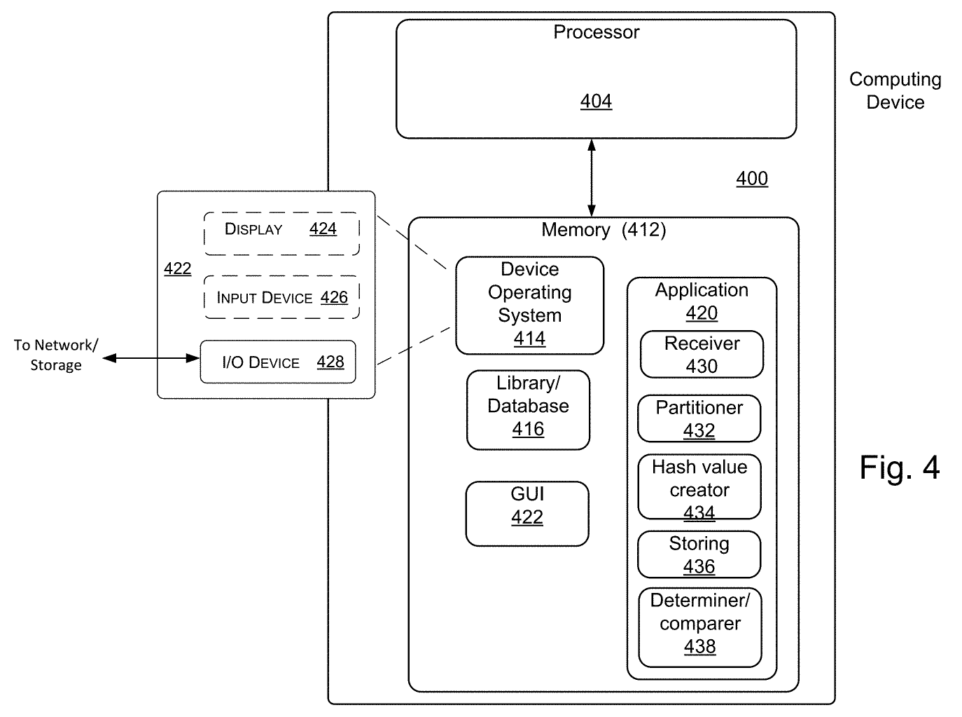

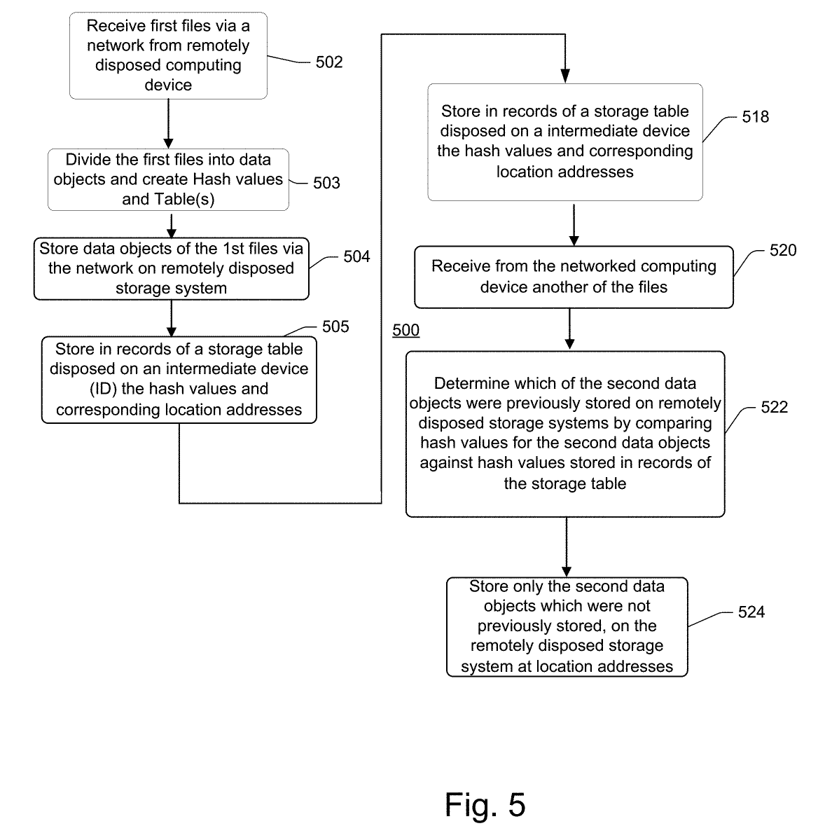

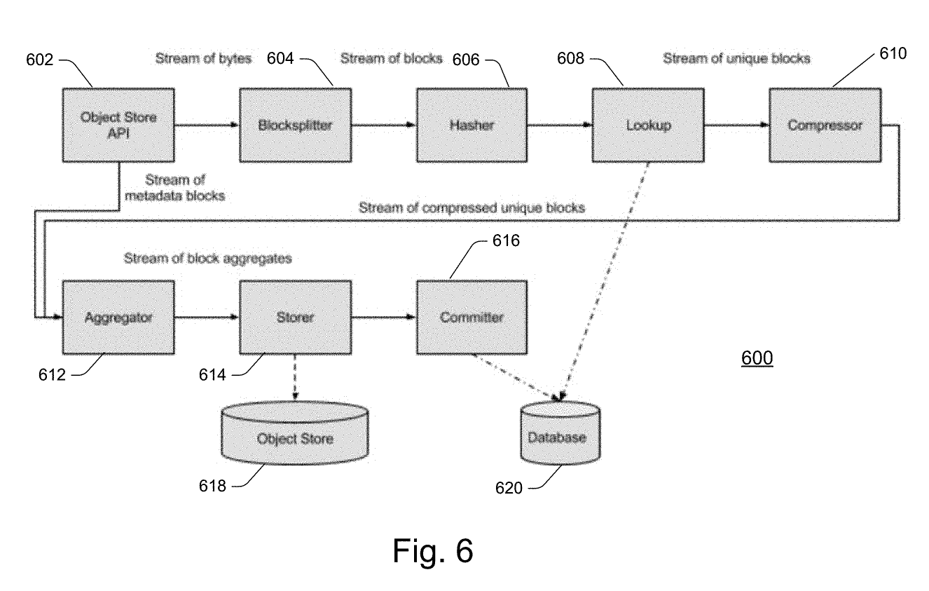

In FIG. 4 are illustrated selected modules in computing device 400 using processes 500 and 600 shown in FIGS. 5-6 respectively to store and retrieve deduplicated data objects. Computing device 400 (such as intermediary computing device 308 shown in FIG. 3) includes a processing device 404 and memory 412. Computing device 400 may include one or more microprocessors, microcontrollers or any such devices for accessing memory 412 (also referred to as a non-transitory media) and hardware 422. Computing device 400 has processing capabilities and memory suitable to store and execute computer-executable instructions.

Computing device 400 executes instruction stored in memory 412, and in response thereto, processes signals from hardware 422. Hardware 422 may include an optional display 424, an optional input device 426 and an I/O communications device 428. I/O communications device 428 may include a network and communication circuitry for communicating with network 304, 310 or an external memory storage device.

Optional Input device 426 receives inputs from a user of the computing device 400 and may include a keyboard, mouse, track pad, microphone, audio input device, video input device, or touch screen display. Optional display device 424 may include an LED, LCD, CRT or any type of display device to enable the user to preview information being stored or processed by computing device 404.

Memory 412 may include volatile and nonvolatile memory, removable and non-removable media implemented in any method or technology for storage of information, such as computer-readable instructions, data structures, program modules or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computer system.

Stored in memory 412 of the computing device 400 may include an operating system 414, a deduplication system application 420 and a library of other applications or database 416. Operating system 414 may be used by application 420 to control hardware and various software components within computing device 400. The operating system 414 may include drivers for device 400 to communicate with I/O communications device 428. A database or library 418 may include preconfigured parameters (or set by the user before or after initial operation) such a server operating parameters, server libraries, HTML libraries, API's and configurations. An optional graphic user interface or command line interface 423 may be provided to enable application 420 to communicate with display 424.

Application 420 includes a receiver module 430, a partitioner module 432, a hash value creator module 434, determiner/comparer module 438 and a storing module 436.

The receiver module 430 includes instructions to receive one or more files via the network 304 from the remotely disposed computing device 302. The partitioner module 432 includes instructions to partition the one or more received files into one or more data objects. The hash value creator module 434 includes instructions to create one or more hash values for the one or more data objects. Exemplary algorithms to create hash values include, but is not limited to, MD2, MD4, MD5, SHA1, SHA2, SHA3, RIPEMD, WHIRLPOOL, SKEIN, Buzhash, Cyclic Redundancy Checks (CRCs), CRC32, CRC64, and Adler-32.

The determiner/comparer module 438 includes instructions to determine, in response to a receipt from a networked computing device (e.g. device hosting application 302) of one of the one or more additional files that include one or more second data objects, if the one or more second data objects are identical to one or more data objects previously stored on the one or more remotely disposed storage systems (e.g. device 312) by comparing one or more hash values for the one or more second data objects against one or more hash values stored in one or more records of the storage table.

The storing module 436 includes instructions to store the one or more data objects on one or more remotely disposed storage systems (such as remotely disposed computing device 312 using API 311) at one or more location addresses, and instructions to store in one or more records of a storage table, for each of the one or more data objects, the one or more hash values and a corresponding one or more location addresses. The storing module also includes instructions to store in one or more records of the storage table for each of the received one or more second data objects if the one or more second data objects are identical to one or more data objects previously stored on the one or more remotely disposed storage systems (e.g. device 312), the one or more hash values and a corresponding one or more location addresses of the received one or more second data objects, without storing on the one or more remotely disposed storage systems (device 312) the received one or more second data objects identical to the previously stored one or more data objects.

Illustrated in FIGS. 5 and 6, are exemplary processes 500 and 600 for De-duplicating storage across a network. Such exemplary processes 500 and 600 may be a collection of blocks in a logical flow diagram, which represents a sequence of operations that can be implemented in hardware, software, and a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes are described with reference to FIG. 4, although it may be implemented in other system architectures.

Referring to FIG. 5, a flowchart of process 500 executed by a deduplication application 420 (See FIG. 4) (hereafter also referred to as “application 420”) is shown. In one implementation, process 400 is executed in a computing device, such as intermediate computing device 308 (FIG. 3). Application 420, when executed by the processing devices, uses the processor 404 and modules 416-438 shown in FIG. 4.

In block 502, application 420 in computing device 308 receives one or more first files via network 304 from a remotely disposed computing device (e.g. device hosting application 302).

In block 503, application 420 divides the received first files into data objects, creates hash values for the data objects or portions thereof, and stores the hash values into a storage table in memory on intermediate computing device (e.g. an external computing device, or system 312).

In block 504, application 420 stores the one or more first files via the network 310 onto a remotely disposed storage system 312 via API 311.

In block 505, optionally an API within system 312 stores within records of the storage table disposed on system 312 the hash values and corresponding location addresses identifying a network location within system 312 where the data object is stored.

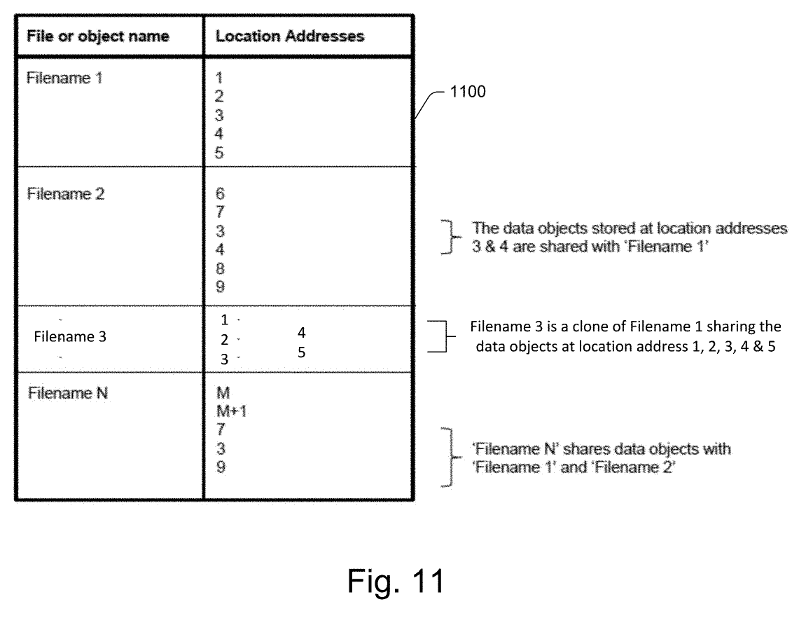

In block 518, application 420 stores in one or more records of a storage table disposed on the intermediate device 308 or a secondary remote storage system (not shown) for each of the one or more data objects the one or more hash values and a corresponding one or more network location addresses. Application 420 also stores in a file table (FIG. 11) the names of the files received at in block 502 and the location addresses created at block 505.

In one implementation, the one or more records of a storage table are stored for each of the one or more data objects the one or more hash values and a corresponding one or more location addresses of the second data object without storage of the second identical data object on the one or more remotely disposed storage systems. In another implementation, the one or more hash values are transmitted to the remotely disposed storage systems for storage with the one or more data objects. The hash value and a corresponding one or more new location addresses may be stored in the one or more records of the storage table. Also the one or more data objects may be stored on one or more remotely disposed storage systems at one or more location addresses with the one or more hash values.

In block 520, application 420 receive from the networked computing device another of the one or more files.

In block 522, in response to the receipt from a networked computing device of another of the one or more files including one or more second data objects, application 420 determine if the one or more second data objects were previously stored on one or more remotely disposed storage systems 312 by comparing one or more hash values for the second data object against one or more hash values stored in one or more records of the storage table.

In block 524, application 420 stores the one or more data objects of the file, which were not previously stored, on one or more remotely disposed storage systems (e.g. device 312) at the one or more location addresses.

In one implementation, the application 420 may deduplicate data objects previously stored on any storage system by including instructions that read one or more first files a stored on the remotely disposed storage system, divide the one or more first files into one or more first file data objects, and create one or more first file hash values for the one or more first file data objects. Once the first hash values are created, application 420 may store the one or more first file data objects on one or more remotely disposed storage systems at one or more location addresses, store in one or more records of the storage table, for each of the one or more first file data objects, the one or more first file hash values and a corresponding one or more first file location addresses, and in response to the receipt from the networked computing device of the another of the one or more files including the one or more second data objects, determine if the one or more second data objects were previously stored on one or more remotely disposed storage systems by comparing one or more hash values for the second data object against one or more first file hash values stored in one or more records of the storage table. The filenames of the second files are stored in the file table (FIG. 11) along with the location addresses of the duplicate data objects (from the first files) and the location addresses of the unique data objects from the second files.

Referring to FIG. 6, there is shown an alternate embodiment of system architecture diagram illustrating a process 600 for storing data objects with deduplication. Process 600 may be implemented using an application 420 in intermediate computing device 308 shown in FIG. 3.

In block 602, the process includes an application (such as application 420) that receives a request to store an object (e.g., a file) from a client (e.g., the “Client System” in FIG. 1). The request typically consists of an object key (e.g., like a filename), the object data (a stream of bytes) and some metadata.

In block 604, the application splits that the stream of data into data objects, using a block splitting algorithm. In one implementation, the block splitting algorithm could generate variable length data objects like the algorithm described in the Rocksoft patent (U.S. Pat. No. 5,990,810) or, could generate fixed length data objects of a predetermined size, or could use some other algorithm that produces data objects that have a high probability of matching already stored data objects. When a block boundary is found in the data stream, a block is emitted to the next stage. The block could be almost any size.

In block 606, each block is hashed using a cryptographic hash algorithm like MD5, SHA1 or SHA2 (or one of the other algorithms previously mentioned). Preferably, the constraint is that there must be a very low probability that the hashes of different data objects are the same.

In block 608, each data block hash is looked up in a table mapping block hashes that have already been encountered to data location addresses in the cloud object store (e.g. a hash_to_block_location table). If the hash is found, then that block location is recorded, the data block is discarded and block 616 is run. If the hash is not found in the table, then the data block is compressed in block 610 using a lossless text compression algorithm (e.g., algorithms described in Deflate U.S. Pat. No. 5,051,745, or LZW U.S. Pat. No. 4,558,302, the contents of which are hereby incorporated by reference).

In block 612, the data objects are optionally aggregated into a sequence of larger aggregated data objects to enable efficient storage. In block 614, the data objects (or aggregate data objects) are then stored into the underlying object store 618 (the “cloud object store” 312 in FIG. 3). When stored, the data objects are ordered by naming them with monotonically increasing numbers in the object store 618.

In block 616, after the data objects are stored in the cloud object store 618, the hash_to_block_location table is updated, adding the hash of each block and its location in the cloud object store 618.

The hash_to_block_location table (referenced here and in block 608) is stored in a database (e.g. database 620) that is in turn stored in fast, unreliable, storage directly attached to the computer receiving the request. The block location takes the form of either the number of the aggregate block stored in block 614, the offset of the block in the aggregate, and the length of the block; or, the number of the block stored in block 614.

In block 616, the list of location addresses from data objects 608-614 may be stored in the object_key_to_location_list (FIG. 11) table, in fast, unreliable, storage directly attached to the computer receiving the request. Preferably the object key and location addresses are stored into the cloud object store 618 using the same monotonically increasing naming scheme as the block records.

The process may then revert to block 602, in which a response is transmitted to the client device (mentioned in block 602) indicating that the data object has been stored.

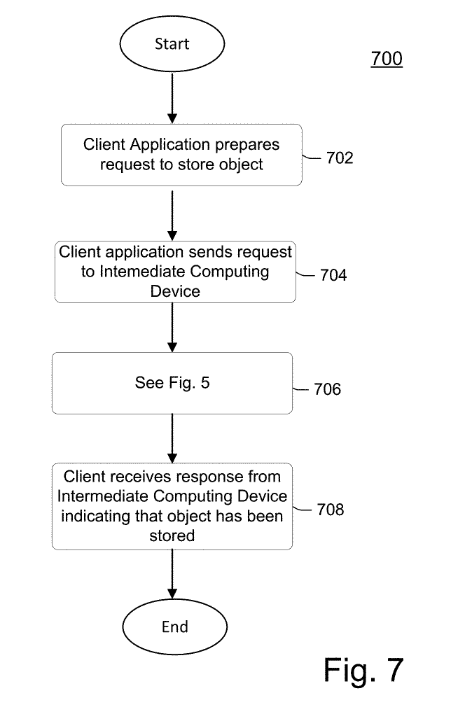

Illustrated in FIG. 7, is exemplary process 700 implemented by the client application 302 (See FIG. 3) for deduplicating storage across a network. Such exemplary process 700 may be a collection of blocks in a logical flow diagram, which represents a sequence of operations that can be implemented in hardware, software, and a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the process is described with reference to FIG. 3, although it may be implemented in other system architectures.

In block 702, client application 302 prepares a request for transmission to intermediate computing device 308 to store a data object. In block 704, client application 302 transmits the data object to intermediate computing device 308 to store a data object.

In block 706, process 500 or 600 is executed by device 308 to store the data object.

In block 708, the client application receives a response notification from the intermediate computing system indicating the data object has been stored.

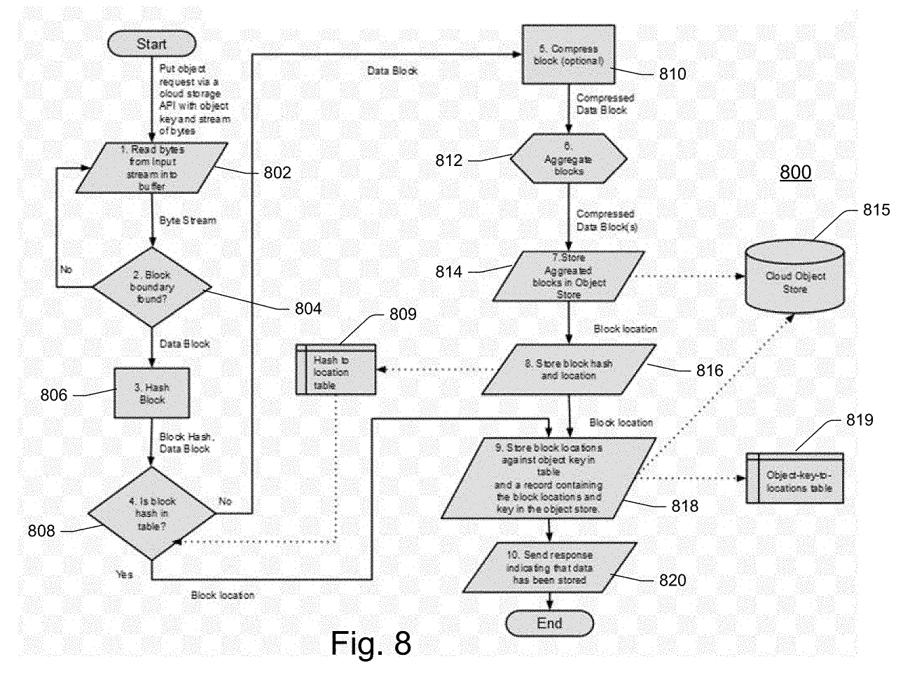

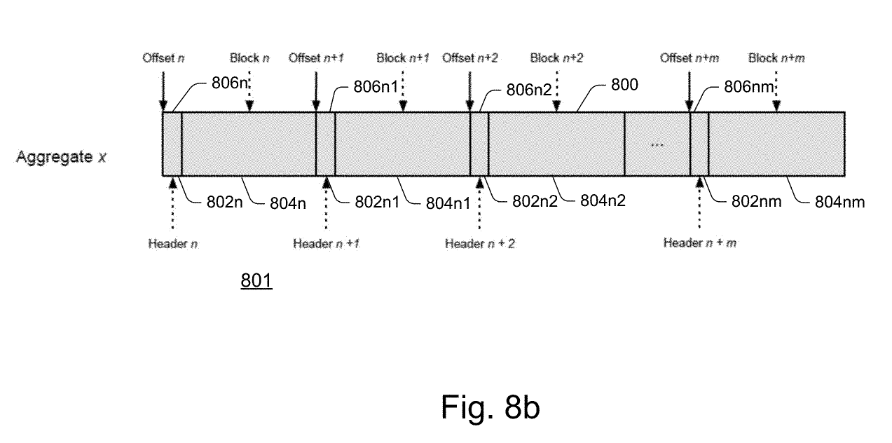

Referring to FIG. 8, there is shown more details of the process described in FIG. 5 for deduplicating objects. In one implementation, process 800 is executed in a computing device, such as intermediate computing device 308 (FIG. 3). When executed by the processing devices, uses the processor 404 and modules 802-820 shown in FIG. 8.

In block 802, in response to a put object request via a cloud API with an object key and a stream of bytes, bytes are read from an input stream into a buffer.

In block 804, in response to a byte steam, a determination is made if a block (also referred to herein as a data object) boundary is found. If it is not found, block 802 is repeated. When a block boundary is found, a data block (data object) is created and hashed in block 806.

In block 808, a determination is made whether an entry for the data block (data object) hash exists in a hash to location table 809. If it is not in table 809, then the data block (data object) is unique and must be stored, in which case the steps in blocks 810, 812, 814 and 816 are carried out. If the hash is in table 809 then the steps in blocks 810, 812, 814 and 816 are skipped.

In block 810 the data block (data object) is compressed. In block 812, one or more data blocks (data objects) are aggregated to create an aggregated data object, and in block 814, the aggregated data object is stored in the object store 815.

In block 816, the block (data object) hashes and locations within the cloud object store are stored in the hash to location table 809.

In block 818, the data block locations (location addresses) are stored against an object key in an object to key to location table 819 and a record containing the block locations (location addresses) are stored in the object store.

In block 820, a response is sent indicating that the data (object) has been stored.

Referring to FIG. 8b, an exemplary aggregate data object 801 as produced by block 612 is shown. The data object includes a header 802n-802nm, with a block number 804n-804nm and an offset indication 806n-806nm, and includes a data block.

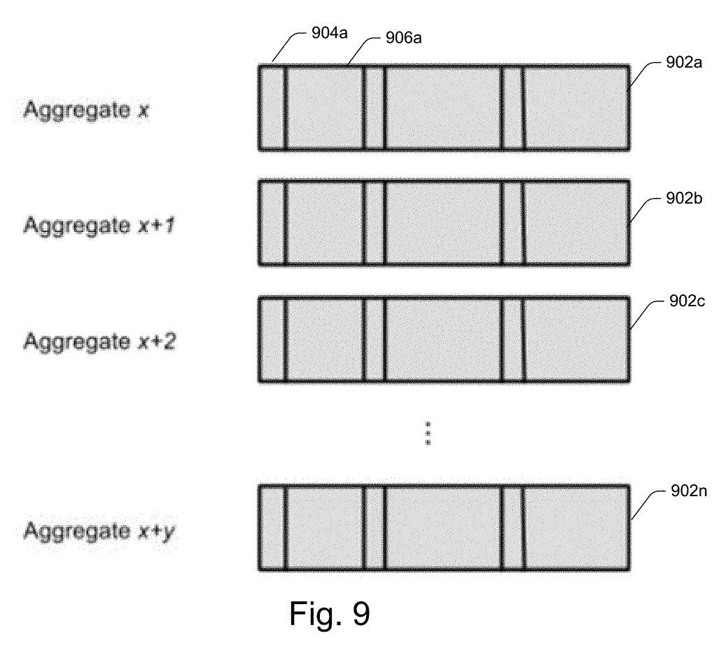

Referring to FIG. 9, an exemplary set of aggregate data objects 902a-902n for storage in memory is shown. The data objects 902a-902n each include the header (e.g. 904a) (as described in connection with FIG. 8b) and a data block (e.g. 906a).

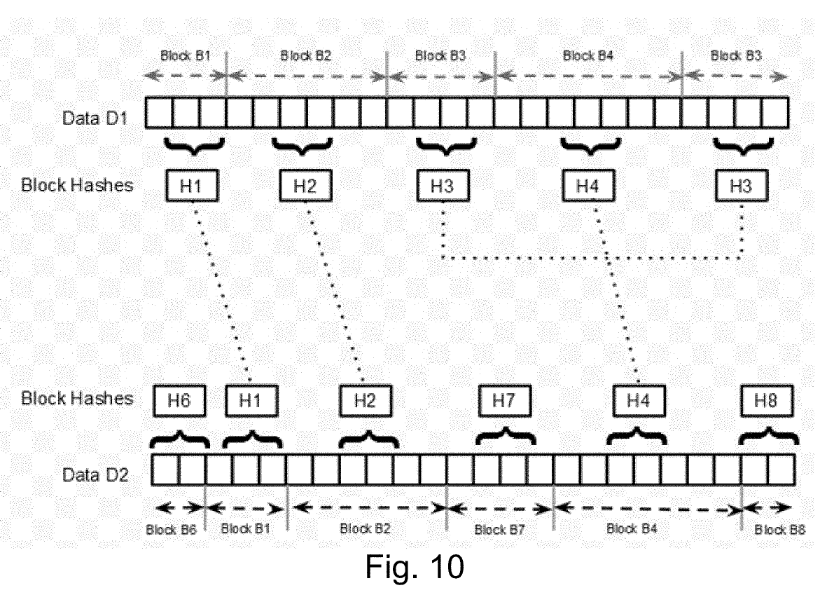

Referring to FIG. 10, an exemplary relation between the hashes (e.g. H1-H8) (which are stored in a separate deduplication table) and two separate data objects D1 and D2 are shown. Portions within data objects B1-B3 of data object (or file) D1 are shown with hashes H1-H4, and portions within data objects B1, B2, B4, B7, and B8 of data object (or file) D2 are shown with hashes H1, H2, H4, H7, and H8 respectively. It is noted that portions of data objects having the same hash value are only stored in memory once with its location of storage within memory recorded in the deduplication table along with the hash value.

Referring to FIG. 11, a table 1100 is shown with filenames (“Filename 1”-“Filename N”) of the files stored in the file table along with their data objects for the files' network location addresses. Exemplary data objects of Filename 1 are stored at network location address 1-5. Exemplary data objects of Filename 2 are stored at location address 6, 7, 3, 4, 8 and 9. The data objects of “Filename 2” are stored at location address 3 and 4 are shared with “Filename 1”. “Filename 3” is a clone of “Filename 1” sharing the data objects at location addresses 1, 2, 3, 4 & 5. “Filename N” shares data objects with “Filename 1” and “Filename 2” at location addresses 7, 3 and 9.

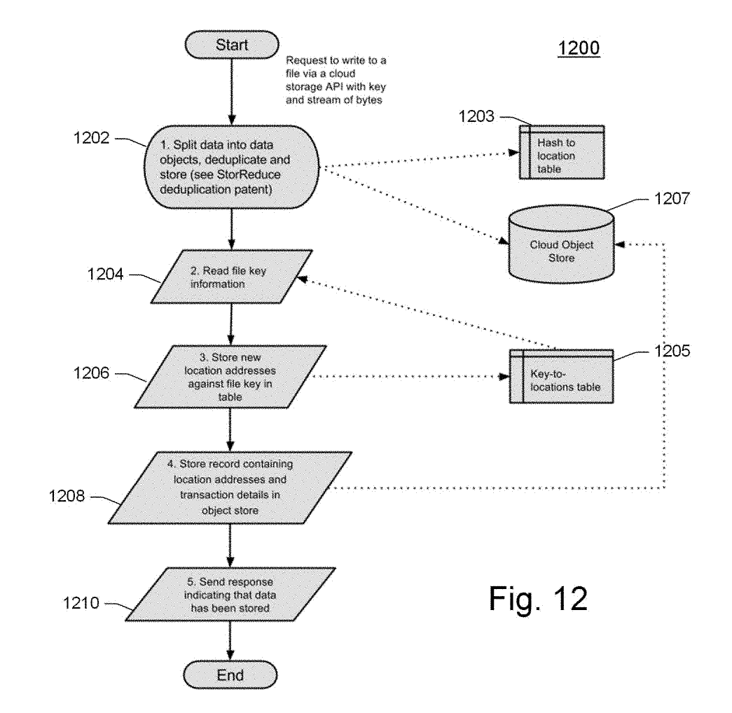

Referring to FIG. 12, there is shown an exemplary process 1200 for writing/uploading new or cloned object data using an intermediary computing device 306 or 400 shown in FIGS. 3 and 4. In process 1200, a series of data objects will be uploaded to the system (such as an object store) to form the initial data to be cloned.

The system (a program running on computing device 306 in FIG. 3) receives a request to store an object (e.g., a file) from a client 302. The request consists of an object key (analogous to a filename), the object data (a stream of bytes) and meta-data. In block 1202, the program will perform deduplication as described previously in connection with FIGS. 1-11, upon the data by splitting the data into data objects (also referred to as ‘data objects’ earlier in this document) and checking whether each block is already present in the system. For each unique block of data, a block record is stored into the Cloud Object Store, and index information is stored into a hash-to-location table 1203.

The supplied object key is checked in block 1204 to see if the key already exists in the object-key-to-location table 1205. For the initial data upload the key will not already exist.

In block 1206, the location addresses for the data objects identified in the deduplication process are stored against the object key in the object-key-to-locations table 1205.

In block 1208, a record of the object key and the corresponding location addresses is sent to the cloud object store 1207 (312 in FIG. 3), using the same naming scheme as the block records.

A response is the sent in block 1210 to the client 302 indicating that the object has been stored.

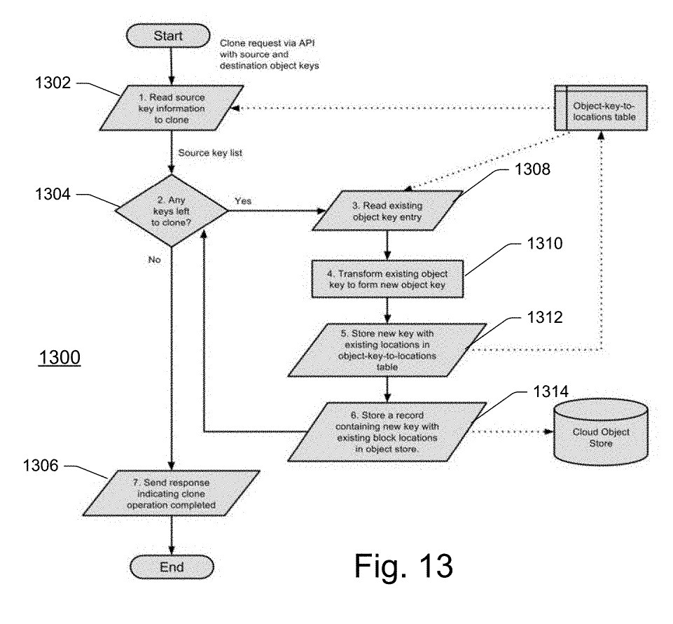

Referring to FIG. 13, there is shown an exemplary process 1300 for creates a writable virtual copy (a ‘clone’) of a subset of the objects using an intermediary computing device 308 or 400 shown in FIGS. 3 and 4.

In block 1302, the system receives a request from a user or client application 302 via the administration interface 306 to Clone data. The request specifies the source of the data as a portion of a key namespace, specifying a subset of the objects in the system to clone, and the destination for the clone operation is specified as a transformation to apply to the source object keys.

In block 1304, the system determines the subset of known files to clone by using the source information specified in the request and reading key information from the object-key-to-location table.

In blocks 1308-1314, the system iterates through the files to clone, each identified by its key (referred to as the ‘source object key’ in the following steps).

In block 1308, information relating to the source object, including the source object key, is read from the object-key-to-location table.

In block 1310, a new ‘destination’ object key is constructed by applying the destination transformation to the source object key. One possible example of such a transformation would be to strip the bucket identifier from the start of the source object key and then prepend a new bucket identifier, this would have the effect of cloning a source bucket into a destination bucket.

In block 1312, the new object key is stored into the object-key-to-locations table, referring to the same set of block location information as the original object. The list of location addresses may be defined by reference (using reference counting, with a reference to the list) rather than by storing a copy of the list. In other words, the system does not actually ‘copy the metadata’ until the cloned object is overwritten (if it ever is). This has the effect of ‘cloning’ the object without copying the block data. This object-key-to-location table may be disposed on a different object store (not shown) than the object store 312.

In block 1314, record of the new object key and the existing set of block location information is sent to the cloud object store, using the same naming scheme as the block records. Steps 1308-1314 are then repeated for the rest of the files to clone.

In block 1306, a response is sent to the client indicating that the clone operation has been completed.

After being cloned one or more times, data can be independently written to any of the clones, at which time the cloned data will diverge. The process for modifying data is the same as for the original upload of data and is shown in FIG. 12.

Referring to FIG. 12, in block 1202, the system receives a request to store new data for an object (e.g., a file) from a client application 302. The request consists of an object key (e.g., like a filename), the object data (a stream of bytes) and some metadata. An object can only be modified through the object store interface by being replaced with an entirely new set of data.

In block 1202, the system will perform deduplication upon the new data by splitting the data into data objects and checking whether each block is already present in the system. Often the new and old data will have data objects in common. Only unique data objects (containing new data) will be stored into the Cloud Object Store and hash-to-location table 1203 as described previously.

In block 1204, the supplied object key is checked to see if it already exists in the object-key-to-location table. When modifying an existing object (including a cloned object) the key will already exist.

In block 1206, the object key in the object-to-locations table is updated to refer to the location addresses for the new data. This will consist of some new data location addresses (identified in block 1202 above) and some existing data location addresses (from the initial data upload before the clone operation took place, or from previous updates to the object).

In block 1208, a record of the object key and the new set of location addresses is sent to the cloud object store 1207, using the same naming scheme as the block records.

In block 1210, a response is sent to the client indicating that the object has been written. To reconstruct the object, the system:
a. looks up the object key, and retrieve the list of locations,
b. retrieves each block from the object store using the location, and
c. joins the data objects together in the order indicated by the list.

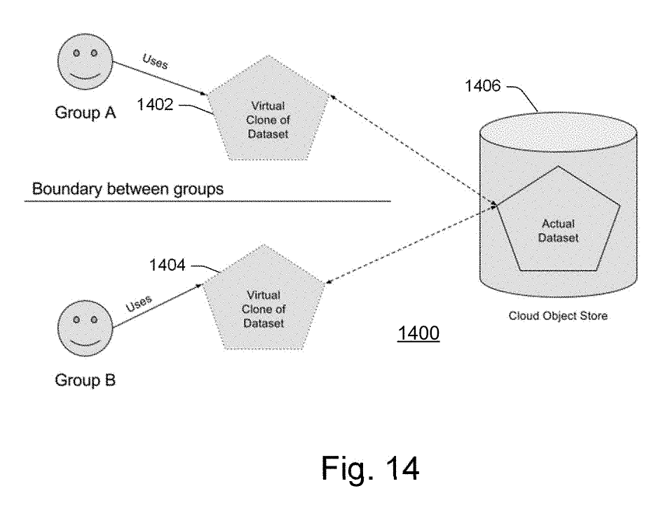

Referring to FIG. 14, there is shown a scenario to create writable virtual copies (clones) of data for different groups (Group A and Group B). These groups could include: client companies, teams within a company separated by a ‘Chinese wall’, and individuals requiring separate data sets containing the same information.

Each group has access only to their own copy of the data, which they are free to modify. No group can see or affect the data of any other group, or even know of their existence.

This situation occurs in regulatory environments where data segregation between teams and companies must be enforced. It also occurs in companies where multiple clients wish to use the same data 1406 but where Group A client data 1402 and Group B client data 1404 must be rigorously segregated.

An example of this scenario is in Genomics research, where multiple teams require access to the same genomics data, but need to modify portions of the data to remove outliers or customize it for their research.

Another example occurs in a consultancy company: a group of consultants A employed by the consultancy is analyzing a dataset for a client company X; a separate team of consultant's B also working for the consultancy B is also analyzing the same dataset for client company Y; both group A and B need to make changes to the dataset. Contractual requirements mean that Group A's clone of the dataset must be provably kept separate from the clone used data used by Group B. Without cloning, the consultancy would have to make copies of the dataset for group A and group B substantially increasing its data storage costs.

Another example occurs in software development. A team of software developers may be developing software that processes the data in a large dataset and modifies that data. Each developer might want to test different aspects of the software, for instance to test what happens if a value in the dataset is outside it's expected range, or to test a feature of the software which will modify some of the data in the dataset. Each developer can take a clone of the dataset, make the modifications that they require (if any) and then perform their tests. During each test, the software is free to update any of the data in the clone of the dataset, without interfering with other tests, or with the original data. After the test the clone can be removed, and a fresh clone created for each additional test run. Without cloning, each developer would need to either make a copy of the dataset (substantially increasing data storage costs) or modify a single shared copy of the dataset (leading to a lack of isolation between test runs and so compromising the testing process).

Another example occurs when IT operations need to test a new software before deployment. IT operations staff who need to test a new version of software against realistic data can make a clone of production data, then run the new software version against the clone. If the software does not function correctly and destroys or corrupts data, the original production data will not be affected. Each new version of the software to be tested can have its own virtual clone of the dataset.

Another example occurs when Quality Assurance staff are testing software and find a problem. By making a virtual clone of the test data at the point of failure, the entire state of the system can be recorded and given to the software developers who need to fix the problem, without requiring additional storage space and cost to store a copy of the dataset.

Another example occurs when using a Hadoop cluster to perform transformations and/or analysis on large quantities of data. By taking a virtual clone of the Hadoop dataset being used before a critical transformation operation, the operation can be rolled back in the event of a problem. This enables more experimentation on the data, and the ability for different groups to perform different transformations on a large data set without interfering with the data being used by other groups.

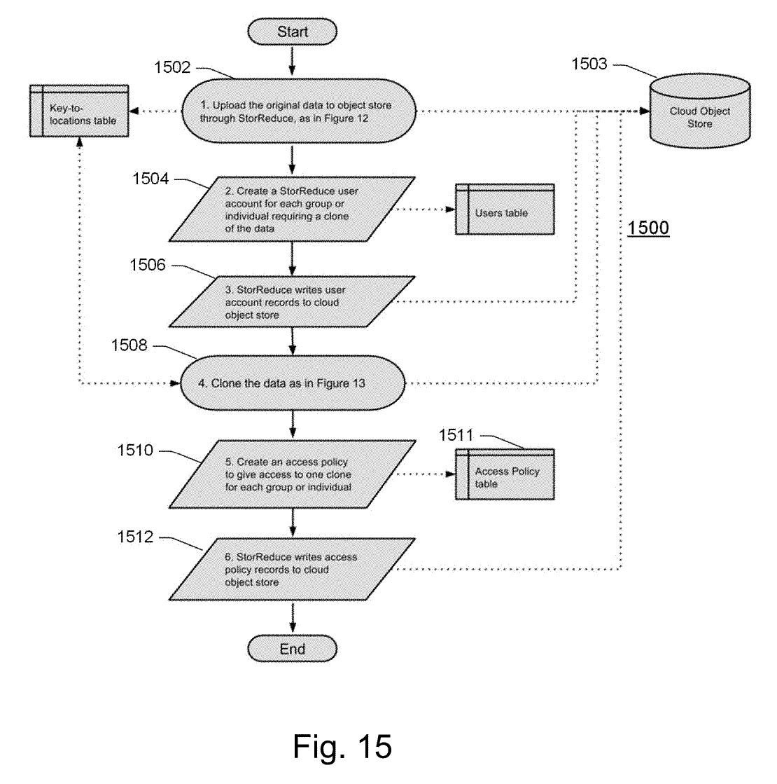

Referring to FIG. 15, there is shown a process 1500 to clone data from where the data from the different groups must be segregated. In block 1502, the data to be cloned and segregated is uploaded to the object store through the process described in connection with FIG. 12.

In block 1504, a user account is created for each group wishing to have access to a clone of the data. These user accounts are recorded in a User table in the system 308.

In block 1506, for each user account a record is written to the cloud object store 1503 (Also 312 of FIG. 3). Writing to the object store 1503, ensures that the user accounts can be utilized in multiple locations and through multiple servers to provide access to the cloned data.

In block 1508, the data is cloned, multiple times if necessary, to provide a separate writable virtual copy for each group. This is performed as described in connection with FIG. 13.

In block 1510, an access control policy is created for each group granting access to their user account for their clone of the data. These access policies are recorded in an Access Policy table 1511 stored in the system 308.

In block 1512, for each access control policy a record is written to the cloud object store 1503. This ensures that segregation between groups can be maintained even when each group can access their own data in multiple locations and through multiple servers.

By storing the combination of unique data objects, key-to-location information, user account information and access policy information in the cloud object store 1503:
access can be provided for groups to their own virtual copies of the data in multiple locations in the cloud and on premises,
global deduplication across all clones and all data stored in the system can be achieved,
segregation can be maintained between the cloned data owned by each group, and
the entire system can be recovered from the cloud object store in the event of a failure.

While the above detailed description has shown, described and identified several novel features of the invention as applied to a preferred embodiment, it will be understood that various omissions, substitutions and changes in the form and details of the described embodiments may be made by those skilled in the art without departing from the spirit of the invention. Accordingly, the scope of the invention should not be limited to the foregoing discussion, but should be defined by the appended claims.

What is claimed is:

1. A processing device to clone one or more files with one or more computing devices comprising:
circuitry to receive one or more files via a network from a remotely disposed computing device;
circuitry to partition the one or more received files into one or more data objects;
circuitry to create a hash value for each of the one or more data objects;
circuitry to store the one or more data objects on one or more remotely disposed storage systems at one or more location addresses;
circuitry to store in one or more records of a storage table, for each of the one or more data objects, the hash value and a corresponding location address;
circuitry to receive an indication to clone one or more of the received files; and
circuitry, responsive to the indication to clone the one or more received files, to clone the one or more received files by storing in one or more records of a second storage table an object key for each cloned file referring to a same set of hash values and the location addresses as corresponding received files from which the cloned file was cloned thereby cloning the one or more first files without copying the one or more data objects.

2. The device of claim 1, wherein the one or more records of the storage tables are stored on a first object store, and wherein the one or more data objects are stored on a second object store.

3. The device of claim 1, wherein the data objects are aggregated and stored in a data store.

4. The device of claim 1, wherein the circuitry to clone the one or more received files by storing in one or more records of a second storage table an object key for each cloned file referring to a same set of hash values and the location addresses as corresponding received files from which the cloned file was cloned includes circuitry to clone the one or more received files by storing in one or more records of a second storage table an object key for each cloned file referring to a same set of hash values and the location addresses by coping the same set of hash values and the location addresses.

5. The device of claim 1, wherein the circuitry to clone the one or more received files by storing in one or more records of a second storage table an object key for each cloned file referring to a same set of hash values and the location addresses as corresponding received files from which the cloned file was cloned includes circuitry to clone the one or more received files by storing in one or more records of a second storage table an object key for each cloned file referring to a same set of hash values and the location addresses by allocating an identification to the set of hash values, mapping the object keys to the identification, referencing a count as to how many keys reference that set of hash values and location addresses.

6. The device of claim 1, wherein circuitry to create a hash value includes circuitry to create hash value using an algorithm that includes at least one of MD2, MD4, MD5, SHA1, SHA2, SHA3, RIPEMD, WHIRLPOOL, SKEIN, Buzhash, Cyclic Redundancy Checks (CRCs), CRC32, CRC64, and Adler-32.

7. A method to clone one or more files received from one or more remotely disposed computing devices comprising:
receiving one or more files via a network from one of the remotely disposed computing devices;
partitioning the one or more received files into one or more data objects;
creating a hash value for each of the one or more data objects;
storing the one or more data objects on one or more remotely disposed storage systems at one or more location addresses;
storing in one or more records of a storage table, for each of the one or more data objects, the hash value and a corresponding location address;
receiving an indication to clone one or more of the received files; and
responding to the indication to clone the one or more received files by cloning the one or more received files by storing in one or more records of a second storage table an object key for each cloned file referring to a same set of hash values and the location addresses as corresponding received files from which the cloned file was cloned thereby cloning the one or more first files without copying the one or more data objects.

8. The method of claim 7, further comprising storing the one or more records of the storage table on a first object store, and storing the data objects are on a second object store.

9. The method of claim 7, further comprising aggregating and storing the data objects in data store.

10. The method of claim 7, wherein cloning the one or more received files by storing in one or more records of a second storage table an object key for each cloned file referring to a same set of hash values and the location addresses as corresponding received files from which the cloned file was cloned includes cloning the one or more received files by storing in one or more records of a second storage table an object key for each cloned file referring to a same set of hash values and the location addresses by coping the same set of hash values and the location addresses.

11. The method of claim 7, wherein cloning the one or more received files by storing in one or more records of a second storage table an object key for each cloned file referring to a same set of hash values and the location addresses as corresponding received files from which the cloned file was cloned includes cloning the one or more received files by storing in one or more records of a second storage table an object key for each cloned file referring to a same set of hash values and the location addresses by allocating an identification to the set of hash values, mapping the object keys to the identification, referencing a count as to how many keys reference that set of hash values and the location addresses.

12. A computer readable storage medium comprising instructions which when executed by a processor comprises:
instructions to receive one or more files via a network from a remotely disposed computing device;
instructions to partition the one or more received files into one or more data objects;
instructions to create a hash value for each of the one or more data objects;
instructions to store the one or more data objects on one or more remotely disposed storage systems at one or more location addresses;
instructions to store in one or more records of a storage table, for each of the one or more data objects, the hash value and a corresponding location address;
instructions to receive an indication to clone one or more of the received files; and
instructions, responsive to the indication to clone the one or more received files, to clone the one or more received files by storing in one or more records of a second storage table an object key for each cloned file referring to a same set of hash values and the location addresses as corresponding received files from which the cloned file was cloned thereby cloning the one or more first files without copying the one or more data objects.

13. The computer readable storage medium of claim 12, further comprising one or more instructions to store the one or more records of the storage table on a first object store, and to store the one or more data objects are on a second object store.

14. The computer readable storage medium of claim 12, further comprising one or more instructions to aggregate and store the data objects in data store.

15. The computer readable storage medium of claim 12, wherein the instructions to clone the one or more received files by storing in one or more records of a second storage table an object key for each cloned file referring to a same set of hash values and the location addresses as corresponding received files from which the cloned file was cloned includes instructions to clone the one or more received files by storing in one or more records of a second storage table an object key for each cloned file referring to a same set of hash values and the location addresses by coping the same set of hash values and the location addresses.

16. The computer readable storage medium of claim 12, wherein the instructions to clone the one or more received files by storing in one or more records of a second storage table an object key for each cloned file referring to a same set of hash values and the location addresses as corresponding received files from which the cloned file was cloned includes one or more instructions to cloning the one or more received files by storing in one or more records of a second storage table an object key for each cloned file referring to a same set of hash values and the location addresses by allocating an identification to the set of hash values, mapping the object keys to the identification, referencing a count as to how many keys reference that set of hash values and the location addresses.
